(19) United States
(12) Patent Application Publication
(10) Pub. No.: US 2011/0032521 A1
(43) Pub. Date: Feb. 10, 2011

(54) SYSTEM FOR USING HIGH ASPECT RATIO, METAL PARTICLES FOR SURFACE ENHANCED RAMAN SPECTROSCOPY (SERS)

(76) Inventors: Kevin W. Powers, Gainesville, FL (US); Paul Louis Carpinone, Tampa, FL (US); Kathryn Ann Finton, Seattle, WA (US); Gary Wayne Scheiffele, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/678,017

(22) PCT Filed: Sep. 12, 2008
(86) PCT No.: PCT/US08/76166

§ 371 Date: Aug. 9, 2010

Related U.S. Application Data
(60) Provisional application No. 60/972,438, filed on Sep. 14, 2007.

(51) Int. Cl. G01J 3/44; B05D 3/00; B05D 3/06; B29C 43/02

(52) U.S. Cl. 356/301; 427/331; 427/535; 264/109

(57) ABSTRACT

In accordance with the invention there are systems and methods of preparing surface enhanced Raman spectroscopy substrate and methods of enhanced detection of an analyte.

### CROSS-REFERENCE TO RELATED APPLICATION

This application claims priority to U.S. Provisional Patent Application Ser. No. 60/972,438 filed on Sep. 14, 2007, and is a national phase application of PCT/US2008/076166 filed on Sep. 12, 2008, the disclosure of which is incorporated by reference herein in its entirety.

### FIELD OF THE INVENTION

The subject matter of this invention relates to surface enhanced Raman spectroscopy (SERS). More particularly, the subject matter of this invention relates to systems and methods for using high aspect ratio, metal particles for SERS.

### BACKGROUND OF THE INVENTION

Surface enhanced Raman spectroscopy (SERS) is a versatile technique for chemical analysis and biological detection. However, the use of SERS as a routine analytical technique has been hampered by the difficulty in obtaining consistent results and the wide variability in metal surfaces used to promote surface enhancements of the Raman signal. Active research is ongoing to remedy this drawback and enable spectroscopists to use SERS as a routine analytical technique.

Accordingly, the present invention solves these and other problems of the prior art by providing a new type of high aspect ratio metal particles with controlled size and surface roughness for use as surface enhanced Raman spectroscopy (SERS) substrates.

### BRIEF DESCRIPTION OF THE DRAWINGS

FIGS. 1A-1D depict schematic illustrations for exemplary methods of preparing a surface enhanced Raman spectroscopy (SERS) substrate.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

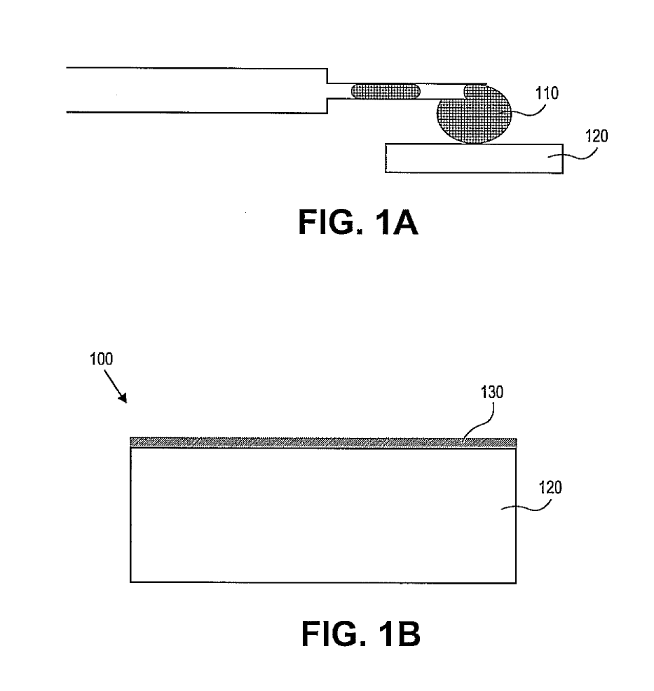

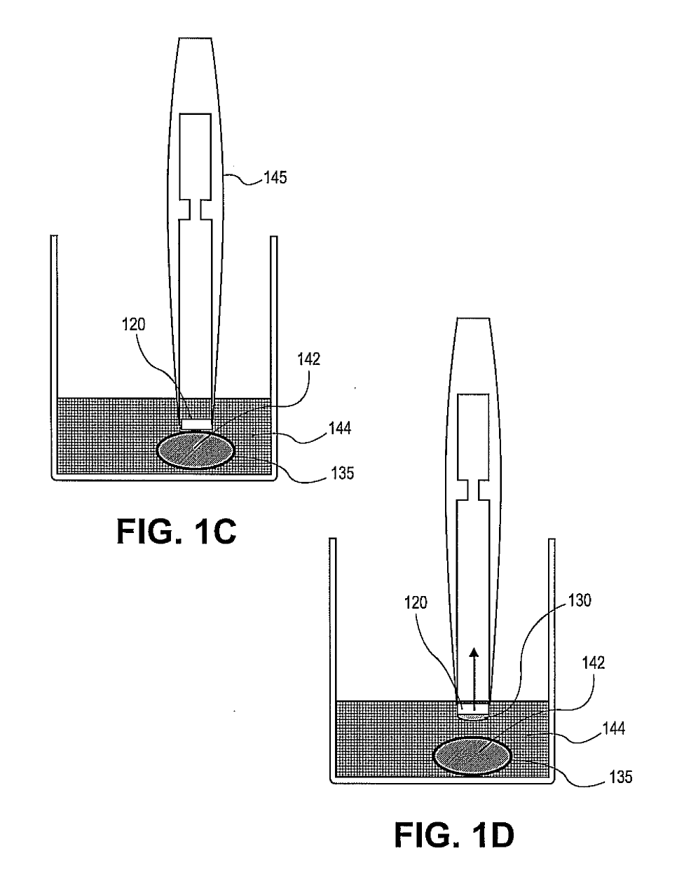

According to various embodiments, there is a method of preparing a surface enhanced Raman spectroscopy (SERS) substrate 100 as shown in FIGS. 1A-1D. The method of preparing a SERS substrate 100 can include providing a solution 110 of high aspect ratio metal particles in a solvent, wherein a major dimension of the high aspect ratio metal particles can be from approximately 10 to approximately 200 times a minor dimension of the high aspect ratio metal particles. In some embodiments, the solution 110 of high aspect ratio metal particles can include a substantially monodisperse size distribution of the high aspect ratio metal particles. In various embodiments, the high aspect ratio metal particles can be selected from the group consisting of platelets, flakes, rods, and nanofibers. In some embodiments, the high aspect ratio metal particles can be formed of gold. In other embodiments, the high aspect ratio metal particles can be formed of any metal with an appropriate plasma frequency, such as, for example, silver, platinum, and palladium. There are various methods of making high aspect ratio metal particles. One such method is disclosed in the United States patent application publication number 20060024250, the disclosure of which is incorporated herein by reference. Exemplary method of making a high aspect ratio metal particles, such as for example, gold platelets can include incorporating an acidified gold chloride salt into a supersaturated silica sol. The sol can then be allowed to gel and can then be heated to about 200° C. to evaporate all of the solvent and cause the metal salt to be reduced, thereby producing metal (e.g. gold) platelets roughly circular to hexagonal in shape embedded in the dried silica gel. The silica can then be dissolved using hydrofluoric acid or strong base leaving the dispersed metal platelets. The size and surface roughness of the metal platelets can be controlled by adjusting the concentration of the metal salt and by adjusting the formulation of the silica gel. In various embodiments, sot formulations can be used to produce different pore sizes in the silica gel affecting the transport (diffusion) and growth of the platelets. For example, varying the acidity of the sol formulation can change the texture and the pore structure of the silica gel within which the metal particles grow. Typically, more acidic sol formulations produce smaller pores and hence finer surface roughness on the surface of the metal particles. Pore size also affects the surface roughness of the flakes which can be used to optimize surface plasmon enhancement for Raman spectroscopy. In various embodiments, the metal platelets can have a diameter in the range of about 1 μm to about 10 μm and thickness in the range of about 50 nm to about 100 nm.

In some embodiments, the step of providing a solution 110 of high aspect ratio metal particles in a solvent can include providing a solution 110 of high aspect ratio metal particles and one or more of a paint and a binder in a solvent.

The method of preparing a SERS substrate 100 can also include forming approximately one or more layers 130 of high aspect ratio metal particles on a substrate 120 by applying the solution 110 of high aspect ratio metal particles onto the substrate 120, as shown in FIGS. 1A and 1B. In some embodiments, the substrate 120 can be selected from any suitable material, preferably one which has a low SERS background signal, such as, for example, glass, quartz, magnesium fluoride, alumina, stainless steel, silicon, and some plastics. In some embodiments, the step of forming a one or more layers 130 of high aspect ratio metal particles on a substrate 129 can include nebulizing (not shown) the solution 110 of high aspect ratio metal particles and spraying onto the substrate 120. In other embodiments, the step of forming one or more layers 130 of high aspect ratio metal particles on a substrate 120 can include delivering a dispersion of flakes onto the substrate with a dropper, as shown in FIG. 1A. In some other embodiments, the step of forming one or more layers 130 of high aspect ratio metal particles on a substrate 120 can include dipping a substrate 120 in the solution 110 of high aspect ratio metal particles and withdrawing the substrate 120 thereby depositing a nominally monolayer or more 130 thick coating of high aspect ratio metal particles on the substrate 120 (not shown).

In another embodiment of the present teachings, the step of providing a solution 110 of high aspect ratio metal particles in a solvent 142 can include adding an immiscible solvent 144 to the solution of high aspect ratio metal particles and forming approximately a monolayer 135 of metal particles at the interface of two immiscible solvents 142 and 144. In various embodiments, the two immiscible solvents 142 and 144 can include polar solvent such as, for example, water and non polar solvent such as, for example, n-dodecane. The method of preparing a SERS substrate 100 can further include dipping a substrate 120 in the solution 110 of high aspect ratio metal particles, as shown in FIG. 1C and withdrawing the substrate 120 thereby depositing a nominally monolayer 130 thick coating of high aspect ratio metal particles on the substrate 120, as shown in FIG. 1D.

In various embodiments, the method of preparing a SERS substrate 100 can also include depositing an analyte onto the substrate 120 (not shown). In other embodiments, the solution 110 of high aspect ratio metal particles can include analyte and thereby metal particles and analyte can be deposited onto the substrate simultaneously.

The method of preparing a SERS substrate 100 can further include removing any undesirable organic residue dissolved in the solvent. In various embodiments, the undesirable organic residue can be removed by oxidizing the organic residue using hydrogen peroxide or other oxidizing agent. In some embodiments, the SERS substrate 100 can be placed in about 40% to about 50% hydrogen peroxide solution and can be incubated at about 50° C. to about 70° C. for about 30 minutes to about 24 hours. In other embodiments, undesirable organic residue can be oxidized by heat treatments in air to a temperature of about 500° C. or other appropriate temperatures. In some other embodiments, undesirable organic residue can be removed by exposing the metal particles to a plasma, such as in a plasma cleaner. In other embodiments, fluorine from the surface of the high aspect ratio metal particles can be removed by placing the SERS substrate 100 in a solution of hydrochloric acid at a temperature from about room temperature to about 100° C. for about 30 minutes to about 24 hours and in some cases from about 50° C. to about 70° C. for about 1 hour to about 6 hours and drying the substrate 100 at about 50° C. In various embodiments, the disclosed SERS substrate 100 can be used with a variety of field deployable Raman spectrometers. Such a spectrometer is provided by several commercial sources such as Ocean Optics Inc. (Dunedin, Fla.) and Raman Systems Inc (Austin, Tex.).

According to various embodiments, there is another method of preparing a SERS substrate including mixing analyte and high aspect ratio metal particles with a transparent powder to form a mixture (not shown), wherein a major dimension of the high aspect ratio metal particles can be from approximately 10 to approximately 200 times a minor dimension of the high aspect ratio metal particles and pressing the mixture to form a pellet, wherein the transparent powder is transparent at the Raman laser wavelength and wherein the pellet can be used as SERS substrate for analyte analysis.

According to another embodiment of the present teachings, there is a method for enhanced detection of an analyte. The method can include adding an analyte to a solution of high aspect ratio metal particles, wherein a major dimension of the high aspect ratio metal particles can be from approximately 10 to approximately 200 times a minor dimension of the high aspect ratio metal particles and conducting at least one of Raman and fourier transform Raman analysis on the solution. In various embodiments, the enhancement can be up to about 10⁵.

According to yet another embodiment of present teachings, there is a method for real time Raman analysis of cultured living cells. The method can include allowing endocytosis of high aspect ratio metal particles into an in-vitro cell culture, wherein a major dimension of the high aspect ratio metal particles can be from approximately 10 to approximately 200 times a minor dimension of the high aspect ratio metal particles. The method can further include conducting real time Raman analysis of the cell culture.

Examples are set forth herein below and are illustrative of different amounts and types of reactants and reaction conditions that can be utilized in practicing the disclosure. It will be apparent, however, that the disclosure can be practiced with other amounts and types of reactants and reaction conditions than those used in the examples, and the resulting devices various different properties and uses in accordance with the disclosure above and as pointed out hereinafter.

### EXAMPLES

### Example 1

### Preparation of SERS Substrates

Several SERS substrates were prepared using a variety of support materials, including magnesium fluoride, stainless steel, glass, quartz, and silicon. Deposition was performed by trapping the hydrophobic gold particles at a polar nonpolar interface and either dip coating the particles onto the support substrate or by placing a droplet containing the particles on the support substrate. The polar phase was water purified to a specific resistivity of 18 MΩ and the non-polar phase consisted of n-dodecane (Acros Organics USA, Morris Plains, N.J.) although other aliphatic hydrocarbons could be used. The gold particles formed a pseudo-monolayer over the support substrate. After deposition, the substrates were placed in an oven at about 60° C. until dry. After drying, the substrates were subjected to cleaning, first with about 1M HCl (Fisher Scientific USA, Pittsburgh, Pa.) and then with about 25% to about 50% hydrogen peroxide (Fisher Scientific USA, Pittsburgh, Pa.) for up to about 48 hours at about 60° C. to remove organic contaminants. Alternatively, the substrates can be cleaned with a plasma cleaner (Harrick Plasma, 2-4 minutes, Ar process gas).

### Example 2

### Testing of SERS Substrates with Urea as Analyte

The SERS substrates prepared in Example 1 were evaluated with urea (Fisher Scientific USA, Pittsburgh, Pa.) as analyte as a test case at a concentration of about 50 mM and about 0.5 mM. One microliter droplet was placed on each of the substrates and allowed to dry. The substrates were analyzed with an in Via™ Raman microscope system (Renishaw, UK) having a laser excitation source at about 785 nm. Samples were scanned from about 200 cm⁻¹ to about 2000 cm⁻¹ at varying laser power and magnification. Glass showed a wide Raman peak at 1360 cm⁻¹ that could masked the analyte peaks, making it less desirable as a support material for urea. Both magnesium fluoride and silicon showed one characteristic peak at about 480 cm⁻¹ and about 520 cm⁻¹ respectively. However, these characteristic peaks of magnesium fluoride and silicon were usually masked by the gold particles and were not readily observed on the substrates and therefore they functioned well as SERS substrate material. Stainless steel and quartz did not contribute any characteristic peaks in the range scanned and performed also well as SERS substrates for urea. Surface enhancement of up to about 10⁵ was observed in these SERS substrates.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “X comprises one or more of A, B, and C” means that X can include any of the following: either A, B, or C alone; or combinations of two, such as A and B, B and C, and A and C; or combinations of three A, B and C.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of preparing a substrate for surface enhanced Raman spectroscopy (SERS) analysis comprising:
providing a solution of high aspect ratio metal particles dispersed in a solvent, wherein a major dimension of the high aspect ratio metal particles is from approximately 10 to approximately 200 times a minor dimension of the high aspect ratio metal particles;
forming approximately one or more layers of high aspect ratio metal particles on a substrate by applying the solution of high aspect ratio metal particles onto the substrate; and
removing any organic residue dissolved in the solvent.

2. The method of claim 1, wherein the high aspect ratio metal particles is selected from the group consisting of platelets, flakes, rods, and nanofibers.

3. The method of claim 1, wherein the step of providing a solution of high aspect ratio metal particles in a solvent comprises providing a solution of high aspect ratio metal particles and one or more of paint and binder in a solvent.

4. The method of claim 1, wherein the step of forming a monolayer of high aspect ratio metal particles on a substrate further comprises:
dipping a substrate in the solution of high aspect ratio metal particles; and
withdrawing the substrate thereby depositing a nominally monolayer thick coating of high aspect ratio metal particles on the substrate.

5. The method of claim 1, wherein the step of forming one or more layers of high aspect ratio metal particles on a substrate further comprises nebulizing the solution of high aspect ratio metal particles and spraying onto the substrate.

6. The method of claim 1, wherein the high aspect ratio metal particles comprises gold flakes.

7. The method of claim 1, wherein the step of providing a solution of high aspect ratio metal particles in a solvent comprises:
adding an immiscible solvent to the solution of high aspect ratio metal particles; and
forming approximately a monolayer of metal particles at the interface of two immiscible solvents.

8. The method of claim 1, wherein the substrate is selected from a group consisting of glass, quartz, magnesium fluoride, alumina, stainless steel, silicon, and plastics.

9. The method of claim 1 further comprising depositing one or more analytes onto the substrate.

10. The method of claim 1, wherein the solution of high aspect ratio metal particles further comprises analyte.

11. The method of claim 1, wherein the step of removing any organic residue dissolved in the solvent comprises oxidizing organic residue using hydrogen peroxide.

12. The method of claim 1, wherein the step of removing any organic residue dissolved in the solvent comprises exposing the metal particles to a plasma.

13. A method of preparing a substrate for SERS analysis comprising:
mixing analyte and high aspect ratio metal particles with a transparent powder to form a mixture, wherein a major dimension of the high aspect ratio metal particles is from approximately 10 to approximately 200 times a minor dimension of the high aspect ratio metal particles; and
pressing the mixture to form a pellet, wherein the pellet can be used as SERS substrate for analyte analysis.

14. A method for enhanced detection of an analyte comprising:
adding an analyte to a solution of high aspect ratio metal particles, a major dimension of the high aspect ratio metal particles is from approximately 10 to approximately 200 times a minor dimension of the high aspect ratio metal particles; and
conducting at least one of Raman and fourier transform Raman analysis on the solution.

15. A method for real time Raman analysis of cultured living cells comprising:
allowing endocytosis of high aspect ratio metal particles into an in-vitro cell culture, wherein a major dimension of the high aspect ratio metal particles is from approximately 10 to approximately 200 times a minor dimension of the high aspect ratio metal particles; and
conducting real time Raman analysis of the cell culture.
